(19) United States
(12) Patent Application Publication
(10) Pub. No.: US 2017/0052543 A1
(43) Pub. Date: Feb. 23, 2017

(54) SYSTEM AND METHOD FOR DIGITIZATION OF VEHICULAR COMPONENTS

(71) Applicant: Sikorsky Aircraft Corporation, Stratford, CT (US)

(72) Inventor: Igor Cherepinsky, Sandy Hook, CT (US)

(21) Appl. No.: 15/237,748

(22) Filed: Aug. 16, 2016

Related U.S. Application Data
(60) Provisional application No. 62/206,540, filed on Aug. 18, 2015.

(51) Int. Cl. G05D 1/10; G01C 23/00; B64D 47/08; B64D 43/00

(52) U.S. Cl. CPC G05D 1/101; B64D 43/00; G01C 23/005; B64D 47/08

(57) ABSTRACT

A system for digitizing components of a vehicle includes a 3-dimensional sensing system operatively arranged to monitor a human-machine interface component of the vehicle, and a controller arranged to receive sensed data from the 3-dimensional sensing system. The controller processes the sensed data and outputs a signal indicative of a condition of the human-machine interface component.

### CROSS REFERENCE TO RELATED APPLICATIONS

This application claims the benefit of an earlier filing date from U.S. Provisional Application Ser. No. 62/206,540 filed Aug. 18, 2015, the entire disclosure of which is incorporated herein by reference.

### BACKGROUND

In a variety of legacy air and ground vehicles, there are numerous human-machine interfaces (“HMI”) components such as levers, dials, gauges, and switches. While many times still functional if maintained, these aging vehicles are operating in the field with older analog existing HMI components that are not automated and unable to use high bandwidth data and/or network data. Attempts have been made to automate such legacy vehicles such as by replacing the older analog legacy HMI components with ones that are capable of both high bandwidth data and/or network data. Alternatively, electro-mechanical transducers can be attached to each HMI component, such that the output of the transducers can be read into a computer system. For legacy analog cockpits, retrofitting the aircraft with sophisticated autopilots or autonomous systems can be very expensive and the aircraft can incur a significant weight penalty. In many cases, the legacy HMI components are pneumatic or hydraulic, and there is no simple way to interface with electronic systems, thus requiring a retrofit with electronic sensors and additional wiring. The time it takes to retrofit the legacy cockpit additionally requires the vehicle to be taken out of service for an extended period of time.

Accordingly, there exists a need in the art for simplifying the digitization of HMI components in a cockpit of a legacy vehicle.

### BRIEF DESCRIPTION

A system for digitizing components of a vehicle includes a 3-dimensional sensing system operatively arranged to monitor a human-machine interface component of the vehicle, and a controller arranged to receive sensed data from the 3-dimensional sensing system. The controller processes the sensed data and outputs a signal indicative of a condition of the human-machine interface component.

In addition to one or more of the features described above or below, or as an alternative, further embodiments could include a 3-dimensional image-capturing device.

In addition to one or more of the features described above or below, or as an alternative, further embodiments could include the 3-dimensional sensing system operatively arranged to monitor a plurality of human-machine interface components.

In addition to one or more of the features described above or below, or as an alternative, further embodiments could include a plurality of 3-dimensional sensing devices, each 3-dimensional sensing device operatively arranged to monitor a plurality of human-machine interface components.

In addition to one or more of the features described above or below, or as an alternative, further embodiments could include at least a subset of the plurality of human-machine interface components monitored by two or more of the plurality of 3-dimensional sensing devices.

In addition to one or more of the features described above or below, or as an alternative, further embodiments could include one or more of a lidar system, 3D camera, and radar.

In addition to one or more of the features described above or below, or as an alternative, further embodiments could include utilization in an aircraft and the human-machine interface component and the 3-dimensional sensing device may be located in a cockpit of the aircraft.

In addition to one or more of the features described above or below, or as an alternative, further embodiments could include the human-machine interface component including at least one of a collective lever, a cyclic stick, and a throttle.

In addition to one or more of the features described above or below, or as an alternative, further embodiments could include the human-machine interface component located on an instrument panel of the aircraft.

In addition to one or more of the features described above or below, or as an alternative, further embodiments could include a controlled device controlled by the condition of the human-machine interface component.

In addition to one or more of the features described above or below, or as an alternative, further embodiments could include an actuator to actuate the controlled device, wherein the actuator is actuatable in response to the signal from the controller.

In addition to one or more of the features described above or below, or as an alternative, further embodiments could include a supervisory control, wherein the supervisory control is arranged to receive the signal from the controller, and arranged to direct actuation of the controlled device through the actuator.

In addition to one or more of the features described above or below, or as an alternative, further embodiments could include the supervisory control, which may be arranged to direct actuation of a plurality of controlled devices.

A method of digitizing components of a vehicle includes arranging a 3-dimensional sensing system to monitor a human-machine interface component of the vehicle; sending sensed data representative of an area including the human-machine interface component from the 3-dimensional sensing system to a controller; processing the sensed data in the controller; and, outputting a signal indicative of a condition of a controlled device directed by the human-machine interface component.

In addition to one or more of the features described above or below, or as an alternative, further embodiments could include actuating a controlled device in response to the signal from the controller.

In addition to one or more of the features described above or below, or as an alternative, further embodiments could include arranging a plurality of 3-dimensional image-capturing devices, each 3-dimensional image-capturing device operatively arranged to monitor a plurality of human-machine interface components.

In addition to one or more of the features described above or below, or as an alternative, further embodiments could include at least a subset of the plurality of human-machine interface components monitored by two or more of the plurality of 3-dimensional image-capturing devices.

In addition to one or more of the features described above or below, or as an alternative, further embodiments could include at least one of a lidar system, 3D camera, and radar.

In addition to one or more of the features described above or below, or as an alternative, further embodiments could include an aircraft as the vehicle and the human-machine interface component and the 3-dimensional sensing system may be located in a cockpit of the aircraft.

In addition to one or more of the features described above or below, or as an alternative, further embodiments could include a method where the vehicle includes the controlled device, an actuator to actuate the controlled device, and an autonomy system, and the method may further send the signal from the controller to the autonomy system, and actuate the actuator in response to the signal.

### BRIEF DESCRIPTION OF THE DRAWINGS

The subject matter which is regarded as the present disclosure is particularly pointed out and distinctly claimed in the claims at the conclusion of the specification. The foregoing and other features, and advantages of the present disclosure are apparent from the following detailed description taken in conjunction with the accompanying drawings in which:

FIG. 1 is a perspective view of an embodiment of a rotary wing aircraft vehicle;

FIG. 2 is a perspective view of an embodiment of a portion of a cockpit and a system for digitizing HMI components for the vehicle of FIG. 1;

FIG. 3 is a perspective view of another embodiment of a portion of a cockpit and a system for digitizing HMI components for the vehicle of FIG. 1;

FIG. 4 is a perspective view of still another embodiment of a portion of a cockpit and a system for digitizing HMI components for the vehicle of FIG. 1;

FIG. 5 is a partly sectional and partly diagrammatic view of an embodiment of a system for digitizing an HMI component; and,

FIG. 6 is a block diagram of a system for digitizing HMI components in the vehicle of FIG. 1.

### DETAILED DESCRIPTION

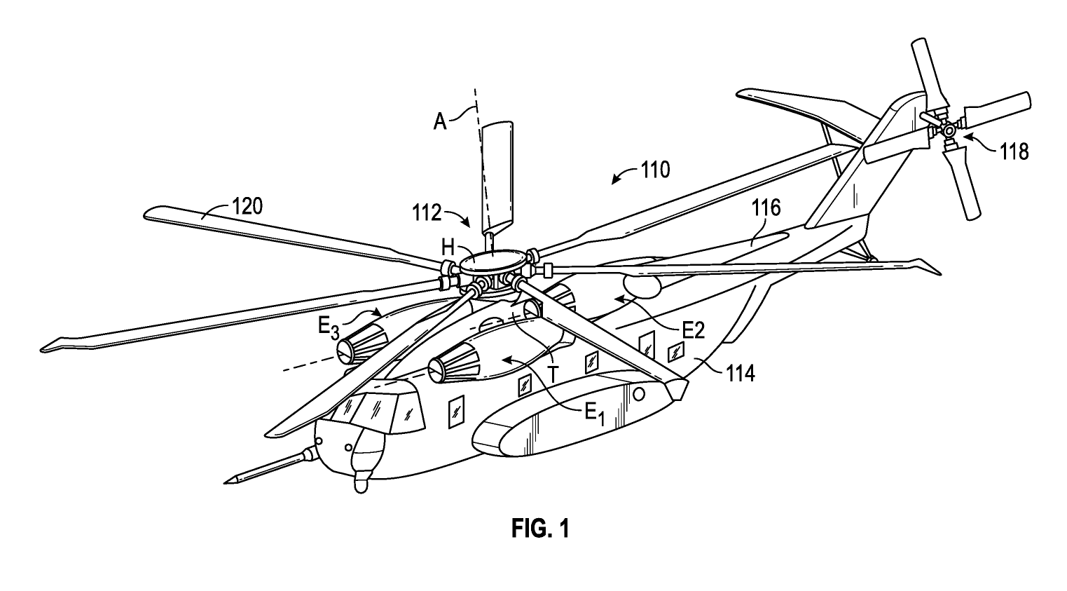

FIG. 1 schematically illustrates an embodiment of a vehicle 110, such as a rotary wing aircraft having a main rotor assembly 112. The vehicle 110 includes an airframe 114 having an extended tail 116 which mounts a tail rotor system 118, such as an anti-torque system, a translational thrust system, a pusher propeller, a rotor propulsion system, and the like. The main rotor assembly 112 includes a plurality of rotor blade assemblies 120 mounted to a rotor hub H, The main rotor assembly 112 is driven about an axis of rotation A through a main gearbox (illustrated schematically at T) by one or more engines E, such as, by example only, E₁, E₂, and E₃. Although a particular helicopter configuration is illustrated and described in the disclosed embodiment as the vehicle 110, other vehicles, configurations, equipment, and/or machines, such as high speed compound rotary wing aircrafts with supplemental translational thrust systems, dual contra-rotating, coaxial rotor system aircrafts, tilt-rotors and tilt-wing aircrafts, and fixed wing aircrafts, as well as land and other legacy equipment and vehicles having legacy analog HMI components, will also benefit from embodiments of the invention.

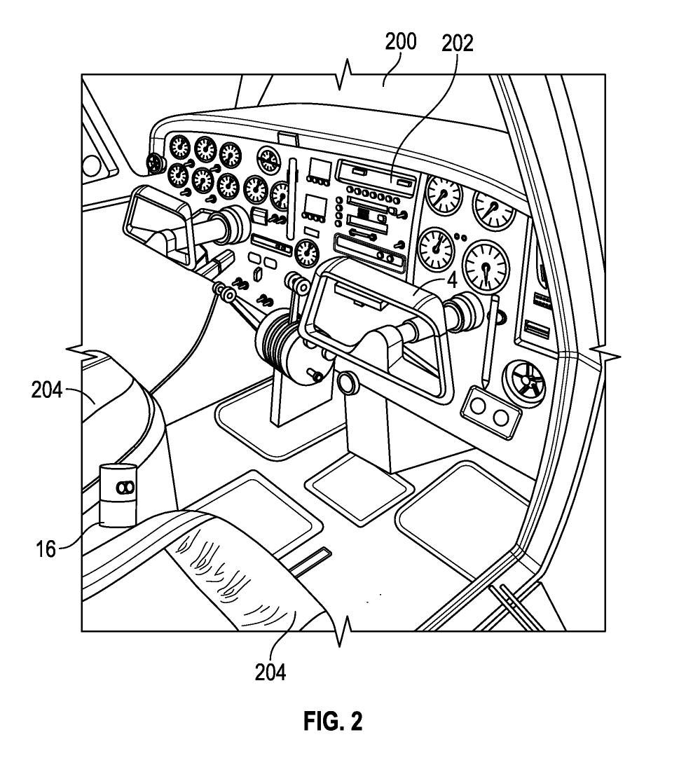

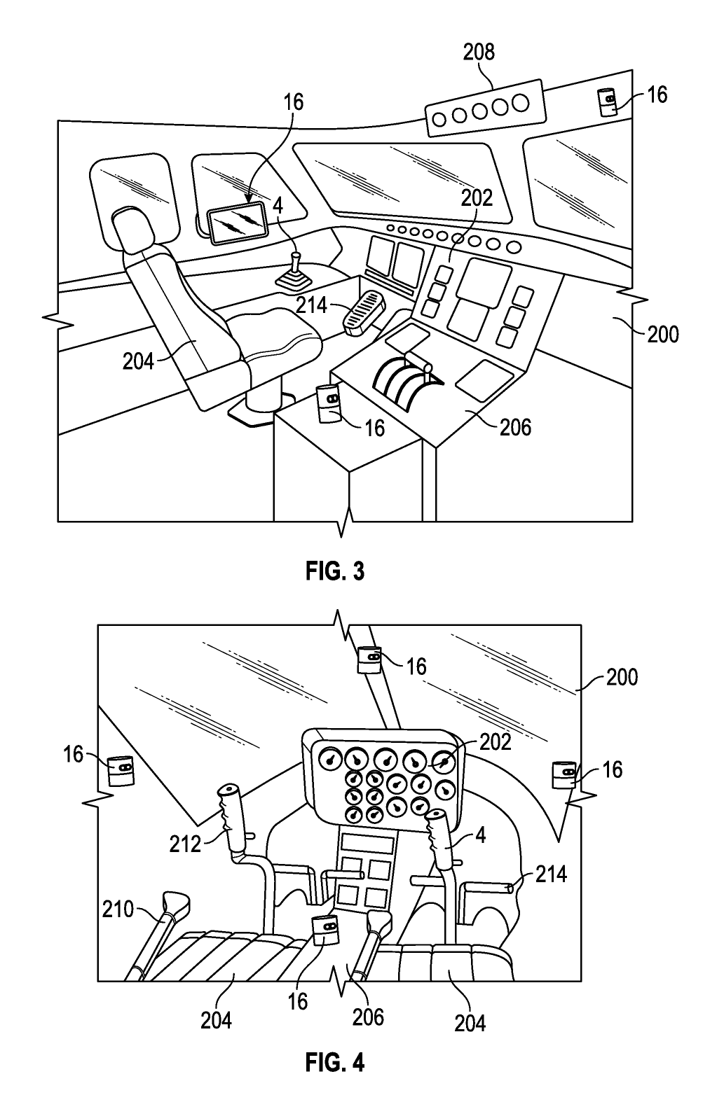

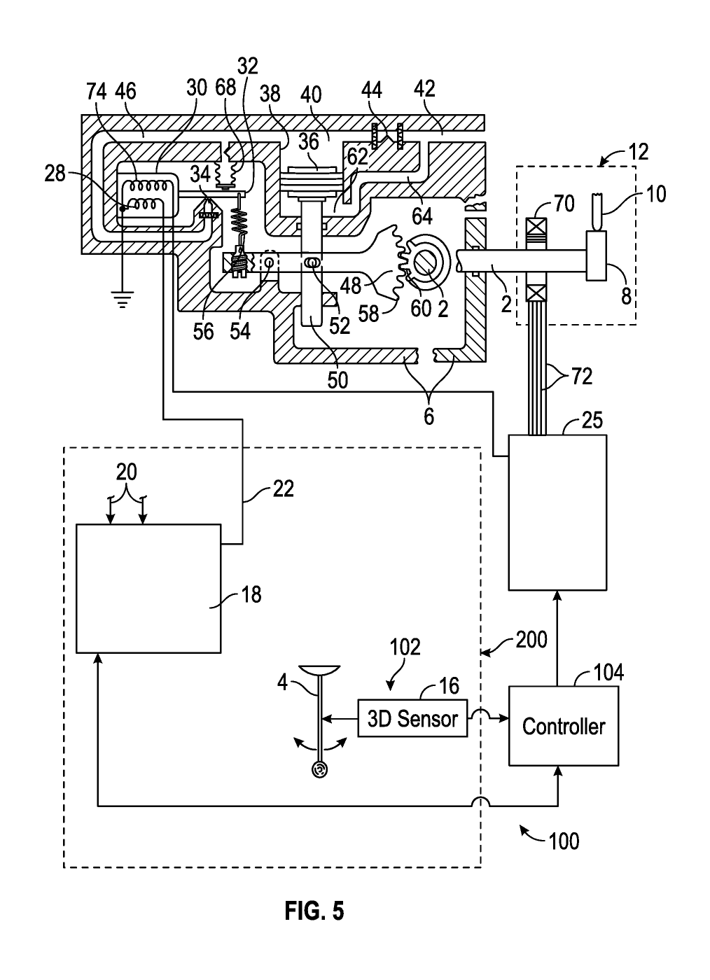

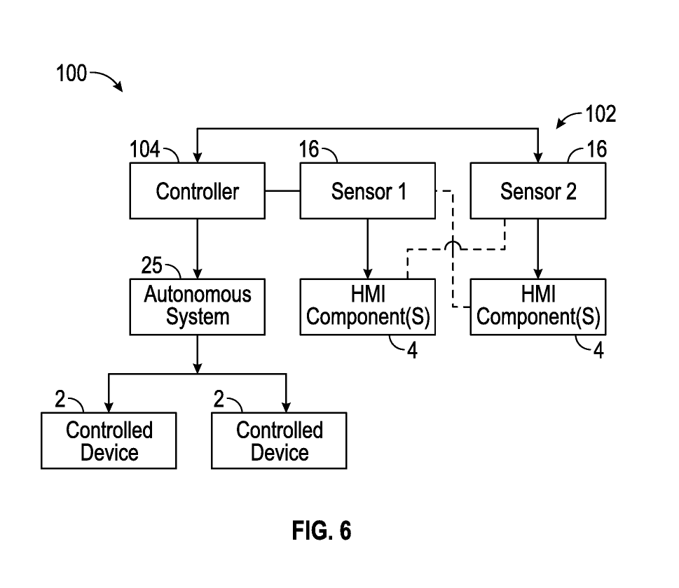

Within the vehicle 110 is a cockpit 200 reserved for the pilots or other operators of the vehicle 110. Various embodiments of a cockpit 200 are depicted in FIGS. 2-4. The cockpit 200 contains a plurality of HMI components 4 (such as, but not limited to, components 4 for controlling controlled devices 2, as illustrated in FIGS. 5 and 6, for actuating control surfaces, lift-increasing flaps and the like, controls for actuating the landing gear, the engines, the air-brakes, switches, needles, gauges, etc. and any other instruments necessary for operating, piloting, and/or driving the vehicle 110. The HMI components 4 may include, but are not limited to, a collective lever 210, cyclic stick 212, directional control pedals 214 (FIG. 4), as well as a throttle, switch, handle, wheel, lever, dial, pedal, and any other operator engageable component 4. The cockpit 200 further includes at least one seat 204 for the operator, The seat 204, or multiple seats 204, are situated within the cockpit 200 so that at least a subset of the HMI components 4 are reachable by and/or within visualization distance of the operator. A first set of components 4 may be positioned on an instrument panel 202 forward of the seat 204. A second set of components may be positioned on a side of the seat 204, such as on a center console 206 (FIGS. 3 and 4) between two adjacent seats 204 in the cockpit 200, and a third set of components may be positioned on a ceiling of the cockpit 200, such as on an overhead console 208 (FIG. 3). Additional components 4 or sets of components 4 may be arranged at alternate locations within the cockpit 200 to allow for easy access and/or visualization by the operator. When at least one of the components 4 is an analog device not initially digitized (contains no transducers that sense displacement of the components 410 send signals therefrom, or any other A/D converter), the location, placement, and/or status of the component 4 is not (without the system described herein) known to a computer controller and therefore not otherwise configured to operate with an autopilot/autonomous system. It should be noted, however, that even components 4 already having an A/D converter may still be digitized using the system described herein, thus providing a redundancy that further ensures accuracy. A mechanical system for connecting the components 4 to their respective controlled devices 2 may suffer from linkage backlash, temperature effects, and vehicle structure deflections. However, a retrofit with transducers, electronic sensors, and additional wiring for each HMI component 4 is time consuming, expensive, and comes with weight penalties.

Thus, as additionally shown in FIGS. 5 and 6, a system 100 for digitizing the HMI components 4 includes a sensing system 102 including at least one sensing device 16. The sensing device 16 may include one or more of a 3D camera, lidar, radar, and any other state of the art sensing system capable of picking up on the depth, position, and characteristics of HMI components 4 as well as operator interaction with the HMI components 4 and converting the HMI components 4 that are sensed by the sensing device 16 to a digital output. That is, while image-capturing devices 16 are illustrated, the sensing system 102 may include any other state of the art sensing devices 16 that can detect the positioning of the HMI components 4. Lidar, for example, is a remote sensing technology that measures distance by illuminating a target with a laser and analyzing the reflected light, known for use in long range applications such as mapping and obstacle detection and avoidance exterior of a unit. Lidar systems include a laser, scanner and optics, photodetector and receiver electronics, and position and navigation systems, The selected sensing devices 16, or combination of sensing devices 16, include relatively low power, eye safe sensing devices 16 that can accurately digitize positions of each HMI component 4, and read gauge dials. The sensing device 16 may be positioned in the cockpit 200 in such a way as to provide full coverage of all the HMI components 4, or a subset of the HMI components 4. A plurality of devices 16 (such as shown in FIGS. 3 and 4) may further be used to provide redundancy and coverage overlap to ensure that failure of a. single sensing device 16 does not result in information loss. The positioning of the devices 16 may further be chosen so as not to interfere with expected operator seating positions within seats 204, so as to eliminate the possibility of operator interference between the sensing device 16 and the HMI components 4 and to facilitate detection of operator interaction with the HMI components 4. Various positions of the sensing devices 16 in the cockpit 200 are illustrated in FIGS. 2-4 but not restricted thereto. The sensing devices 16 are installed in the cockpit 200 and aimed towards at least a subset of the desired HMI components 4. Sensed data, including but not limited to sensed images, from the sensing devices 16 may be streamed continuously or captured periodically.

Turning now to FIG. 5, one embodiment of an HMI component 4 for operating a controlled device 2 is depicted. In the illustrated embodiment, the HMI component 4 is a throttle and the controlled device 2 is a fuel control shaft, however it should be understood that any HMI component 4 within a cockpit 200 might be digitized using the system 100 described herein, and accordingly any controlled device directed by the HMI component 4 may be utilized. Thus, the following details of the controlled device 2 are provided as only one example of a controlled device 2 that is directed by an HMI component 4 and not meant to be limiting in any way as to the type of HMI components 4 that can be digitized or the types of controlled devices 2 that are directed by their respective HMI components. In the illustrated embodiment of FIG. 5, an actuator 6 is arranged to cause a predetermined turning movement of the controlled device 2 (fuel control shaft) when the HMI component 4 (cockpit throttle) is moved through a predetermined angle. The controlled device 2 (shaft) is shown in two positions in the drawing, one position being at right angles to the other and, to emphasize this, the box for the actuator 6 is shown as broken away in the area in which the controlled device 2 (shaft) is journaled.

The controlled device 2 (shaft) may carry a cam 8 that engages a follower 10 forming part of the computer mechanism of the fuel control, this mechanism serving to control the fuel quantity based on the angular position of the cam. The fuel control is represented by the box 12 and may be any of several known controls. In the illustrated embodiment, the fuel control has the projecting controlled device 2 (shaft), which for controlling fuel supply to the engine is turned in proportion to the movement of the HMI component 4 (throttle).

In prior systems, transducers are placed in juxtaposition to the HMI component 4 (throttle) and connected thereto so that proportional displacement of the transducers by displacement of the HMI component 4 (throttle) will result in two signals, one from each transducer, which are sent to a box 18 which utilizes vehicle D.C. power represented by the leads 20 to produce two equal amplified signals, also proportionate to throttle movement. However, as noted above, installation of such transducers for each HMI component 4 is time consuming, expensive, and comes with a weight penalty. Thus, the system 100 instead includes a sensing system 102 including the sensing device 16, such as one or more image capturing devices, which may be easily retrofitted in the cockpit 200. The sensed image of the HMI component 4 and its particular orientation are sent to a controller 104 including a processor, memory, and may further include a database. The processor within the controller 104 may execute one or more instructions that may cause the system 100 to take one or more actions, such as digitizing the sensed data (including sensed images) from the sensing devices 16 and comparing the digitized data with other data stored in the database within the controller 104, or utilizing the digitized data in algorithms stored in the database. By comparing the digitized data with other data or utilizing the digitized data in algorithms, a signal indicative of the condition of the HMI component 4 may be sent for appropriate follow-up action or actions to be accomplished by one or more of the controlled devices 2. After determining appropriate follow-up action or actions, the processor may further execute instructions to send appropriate response signals to a controller of the actuator 6 for responding to the sensed and digitized data from the HMI component 4. The instructions may be stored in the memory.

Data stored in the database may be based on data received from the sensing device(s) 16. In some embodiments, the data stored in the database may be based on one or more algorithms or processes. For example, in some embodiments data stored in the database may be a result of the processor having subjected data received from the sensing device(s) 16 to one or more filtration processes. The database may be used for any number of reasons. For example, the database may be used to temporarily or permanently store data, to provide a record or log of the data stored therein for subsequent examination or analysis, etc. In some embodiments, the database may store a relationship between data such as one or more links between data or sets of data. The controller 104 provides the sensed and processed signal to an autonomy system or supervisory control 25.

In one embodiment, the controller 104 may only provide the sensed and processed signal to the supervisory control 25. In another embodiment, for redundancy, the controller 104 may additionally provide the sensed and processed signal to the box 18, which in turn conducts a signal by lead 22 to the actuator 6 (such as the illustrated electrohydraulic actuator). Whether or not redundant signals are sent, the embodiments disclosed in FIGS. 5 and 6 do not require any mechanical connections between the HMI component 4 and the actuator 6 or the supervisory control 25.

While a particular actuator 6 will be described for the controlled device 2, it should be understood that actuators 6 will be designed differently for each controlled device 2, and thus the particular embodiment described herein is merely illustrative of one possible embodiment of an actuator 6 for one embodiment of a controlled device 2. For example, the controlled device 2 could instead be a light, in which case the condition of the light from on to off, or levels therebetween, would be controlled in an entirely different fashion than the actuator 6 for a fuel shaft.

In one embodiment of an actuator 6 for a fuel shaft, as shown in FIG. 5, the signal from box 18 to the actuator 6 energizes one coil 28 of a torque motor 30. This results in an unbalance on the torque motor arm 32, displacing it toward or away from a nozzle 34 depending on the direction of movement of the HMI component 4 (throttle), as monitored by the sensing device 16. The change in nozzle area produces an unbalance on a hydraulic piston 36 in a cylinder 38. The space 40 above the piston 36 in the cylinder 38 is supplied by fluid through a passage 42 having a fixed constriction 44 therein. The nozzle 34 is also connected to the space 40 by a passage 46.

As the arm 32 moves relative to the nozzle 34, the resulting change in the rate of flow to or from the space 40 above the piston 36 produces a hydraulic unbalance on the piston 36 resulting in piston displacement and a corresponding movement of the lever 48 to which the piston rod 50 is connected as by a pin 52. This lever 48 is pivoted on a fixed pin 54, and the end of the lever 48 is connected by a feedback spring 56 to the end of the torque motor arm 32. As the piston 36 is moved with a resulting movement of the lever 48, the changing load on the spring 56 restores the force balance on the torque motor arm 32 and thus the piston displacement is proportional to the signal to the torque motor 30 and thus proportional to throttle movement. The displacement of the piston 36 is transmitted to the fuel control shaft (controlled device 2) by a gear segment 58 on the end of the lever 48 remote from the spring 56. This segment engages a gear 60 on the fuel control shaft (controlled device 2). The result is angular movement of the shaft proportional to throttle lever movement. The space 62 beneath piston 36 is connected to the fluid passage 42 upstream of the constriction 44 by a passage 64. This space 62 is thus supplied by the constant pressure source for passage 42. In the absence of friction, gear backlash, tolerances, and the like, the actual control shaft position is accurately maintained relative to the desired position.

The signal from the controller 104 to the supervisory control 25 may serve to trim actual control shaft position for errors introduced by sources such as those above mentioned, or may be used to instruct the control 25 on the intended condition input by the HMI component 4. Actual shaft position may be transmitted by a signal from a resolver transducer 70 surrounding the shaft (controlled device 2), by leads 72 to the supervisory control 25 where it is compared to the throttle transducer signal from the controller 104. Any error between the signals may be used to generate a proportional signal to a second torque motor coil 74, producing a force unbalance on the torque motor arm 32 until the shaft position error is reduced effectively to zero. In order to enhance the performance of this system, bellows 68, connected to passage 46, may be positioned to engage the torque motor arm 32 or nozzle flapper to provide a negative spring rate for the nozzle flapper displacement system. The bellows 68 is sized to reduce the total system spring rate approximately to zero for steady state conditions. This serves to reduce the error in the signal to the torque motor 30 required to overcome friction in the system.

In one embodiment, the HMI components 4 may be altered to remove the direct or physical connections between one or more of the components 4 and their respective actuatable devices. For example, if a throttle position lever is to be digitized, the underlying cable may be removed. The system 100 will digitize the position of the component 4 and command the actuator 6 to the digitized condition, which will in turn have the desired affect on the controlled device 2, whether that be to turn from on to off, rotate a certain number of degrees, release or engage a device, etc.

The digital output of the HMI components 4 is used to recognize position or status of the components 4. A processing element in the controller 104 receives data from the sensing device 16 in real time and digitizes the components 4, An algorithm for the system 100 recognizes positions/status of the components 4 and forwards the information to an supervisory control 25 for actuation of the controlled device 2. As shown in FIG. 6, a plurality of sensing devices 16 may be employed. Also, each sensing device 16 may sense the movement of one or more HMI components 4. Further, there may be overlap in the sensing devices 16 with respect to the HMI components 4 to provide redundancy and ensure that each HMI component 4 is monitored.

Thus, the system 100 provides a simple, cost effective way to digitize cockpit HMI components 4, including any sort of controls and displays, while providing sufficient reliability. Because putting an analog-to-digital converter on every component 4 is expensive, time-consuming, and comes with a weight penalty, the method described herein senses the components 4, such as, but not limited to taking images of the components 4 using the sensing device(s) 16, and uses the sensed data to assign a digital value that corresponds to a directed condition of the controlled device 2. The sensed positions of the controls, switches, gauges, and other components 4 taken by the sensing system 102 will be processed by the controller 104 so as to digitize the positions of the components 4 so that the controlled device 2 does not need to be mechanically linked to the components 4, nor does each individual component 4 require a separate A/D converter. After the system 100 is installed, it is further possible to remove legacy wiring from the components 4, while retaining the original components for use. That is, if the system 100 is fully automated, then only the position of the components 4 as directed by the operator is necessary, and not the actual result (e.g. control of flaps, landing gear, lights, etc.) of the repositioning of the components 4. In other words, the components 4 and the devices 2 that they control do not need to be directly linked, and movement of the components 4 will be digitized and sent to an autonomy system 25 (including flight control computer, vehicle management computer, etc.) for subsequent control of the controlled devices 2. With no particular hard-wiring required between the devices 2 and the components 4, weight reduction of the vehicle 110 can be realized.

The system 100 may also be used for optionally piloted vehicles 110, as it allows both modes of operation—manned and unmanned. The system 100 may further enable a reduction of operators required for a particular manned vehicle 110.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

1. A system for digitizing components of a vehicle, the system comprising:
a 3-dimensional sensing system operatively arranged to monitor a human-machine interface component of the vehicle; and,
a controller arranged to receive sensed data from the 3-dimensional sensing system;
wherein the controller processes the sensed data and outputs a signal indicative of a condition of the human-machine interface component.

2. The system of claim 1, wherein the 3-dimensional sensing system includes an image-capturing device and the sensed data includes sensed images.

3. The system of claim 1, wherein the 3-dimensional sensing system is operatively arranged to monitor a plurality of human-machine interface components.

4. The system of claim 3, wherein the 3-dimensional sensing system includes a plurality of 3-dimensional sensing devices, each 3-dimensional sensing device operatively arranged to monitor a plurality of human-machine interface components.

5. The system of claim 4, wherein at least a subset of the plurality of human-machine interface components are monitored by two or more of the plurality of 3-dimensional sensing devices.

6. The system of claim 1, wherein the 3-dimensional sensing system includes a lidar system.

7. The system of claim 1, wherein the 3-dimensional sensing system includes a 3D camera.

8. The system of claim 1, wherein the 3-dimensional sensing system includes radar.

9. The system of claim 1, wherein the vehicle is an aircraft and the human-machine interface component and the 3-dimensional sensing system are located in a cockpit of the aircraft.

10. The system of claim 9, wherein the human-machine interface component is at least one of a collective lever, a cyclic stick, and a throttle.

11. The system of claim 9, wherein the human-machine interface component is located on an instrument panel of the aircraft.

12. The system of claim 1, further comprising a controlled device controlled by the condition of the human-machine interface component.

13. The system of claim 12, further comprising an actuator to actuate the controlled device, wherein the actuator is actuatable in response to the signal from the controller.

14. The system of claim 13, further comprising a supervisory control, wherein the supervisory control is arranged to receive the signal from the controller, and arranged to direct actuation of the controlled device through the actuator.

15. The system of claim 14, wherein the supervisory control is arranged to direct actuation of a plurality of controlled devices.

16. A method of digitizing components of a vehicle, the method comprising:
arranging a 3-dimensional sensing system to monitor a human-machine interface component of the vehicle;
sending sensed data representative of an area including the human-machine interface component from the 3-dimensional sensing system to a controller;
processing the sensed data in the controller; and,
outputting a signal indicative of a condition of the human-machine interface component.

17. The method of claim 16, further comprising:
actuating a controlled device in response to the signal from the controller.

18. The method of claim 17, wherein arranging a 3-dimensional sensing system includes arranging a plurality of 3-dimensional image capturing devices, each 3-dimensional image capturing device operatively arranged to monitor a plurality of human-machine interface components.

19. The method of claim 18, further comprising arranging two or more of the plurality of 3-dimensional image capturing devices to monitor at least a subset of the plurality of human-machine interface components.

20. The method of claim 16, wherein the 3-dimensional sensing system includes at least one of a lidar system, 3D camera, and radar.

21. The method of claim 16, wherein the vehicle is an aircraft and the human-machine interface component and the 3-dimensional sensing system are located in a cockpit of the aircraft.
